(19) United States
(12) Patent Application Publication
(10) Pub. No.: US 2008/0231221 A1
(43) Pub. Date: Sep. 25, 2008

(54) ARM-EQUIPPED MOBILE ROBOT AND METHOD FOR CONTROLLING THE SAME

(75) Inventor: Hideki Ogawa, Yokosuka-shi (JP)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: KABUSHIKI KAISHA TOSHIBA

(21) Appl. No.: 12/045,905

(22) Filed: Mar. 11, 2008

(30) Foreign Application Priority Data
Mar. 22, 2007 (JP) 2007-075504

(51) Int. Cl. B25J 19/06; B25J 5/00; B25J 9/06

(52) U.S. Cl. 318/568.12; 318/568.16

(57) ABSTRACT

A mobile robot contains a movable robot body, arms provided on the movable robot body, each of the arms having a multiple joint structure including plural joints, an actuator for actuating each of the joints and shaft torque sensors incorporated in each of the joints to detect a torque from the actuator at an output shaft of each of the joints, and a controller provided in the robot body to determine whether each of the arms is in contact with or in collision with a peripheral obstacle or obstacles based on change of an output from the shaft torque sensors and control an operation of each of actuators of each arm.

### CROSS-REFERENCE TO RELATED APPLICATIONS

This application is based upon and claims the benefit of priority from prior Japanese Patent Application No. 2007-075504, filed Mar. 22, 2007, the entire contents of which are incorporated herein by reference.

### BACKGROUND OF THE INVENTION

1. Field of the Invention

The invention relates to a mobile robot equipped with working arms, and more particularly, a technology concerning security of a robot at the time of arm work and movement.

2. Description of the Related Art

In recent years, an arm-equipped mobile robot for working has been developed as a robot assumed to carry out a work in the environment where there are persons around the robot, that is, in public institution or home, as well as a conventional industrial use robot.

When an arm-equipped mobile robot works moving equipped arm of multiple joints structure with the robot main body, it is important that it performs control such as operation stop by detecting that the robot is in contact with or in collision with a person and object around the robot, and certain safety precaution is given not to harm to the person and object.

Therefore, in order to detect and avoid contact or collision of the articulated arm (manipulator) with environment of circumference, there is provided a method of carrying out operation for avoiding contact and collision in impedance control, for example, a tactile sensor for external force detection is provided on the surface of the articulated arm as disclosed in JP-A 2001-38664 (KOKAI), and further a force sensor is installed in a wrist portion.

Further, JP-A 2006-21287 (KOKAI) discloses a technology wherein a force detector is installed on the base of the multijoint arm, a force corresponding to an external force occurring by the operation of the arm itself is estimated and calculated, and a value corresponding to the estimated external force is subtracted from the output of the force detector to detect a contact force.

JP-A 2004-364396 (KOKAI) discloses a method for detecting contact of an arm with an object based on a difference between a quantity of state and a torque directive value of a simulation result based on a model under control of the arm.

JP-A H08-118275 (KOKAI) proposes a technology of performing torque feedback control using a shaft torque sensor to operate an arm itself in force control.

However, the above documents are directed to only a multiple joint arm as a robot, and do not discuss an arm-equipped robot that works as moving itself. Accordingly, the work of the robot is limited to a handling work using only an arm. It is not considered to operate the robot more effectively by switching ways to cope with contact, collision, etc. when the robot is in contact with or in collision with peripheral obstacles according to various working states (working modes) such as a locomotive operation to the designated position, an operation for positioning the arm fingers to a specific object accompanied with a locomotive operation of the robot itself or a standby state Further, in the above documents, there are problems that a method of detecting contact or collision with a person or obstacles makes mounting of a sensor difficult, makes calculation complicated and makes detection precision poor.

Concretely, in the case of JP-A 2001-38664 (KOKAI), when a contact sensor is attached to the surface of the arm, it is difficult to attach and arrange the contact sensor to and on the entire surface of the arm. When an array sensor is used, a signal processing is complicated and needs large operation time.

Further, in the case of JP-A 2006-21287 (KOKAI), there are problems that when an acceleration sensor is installed on the arm finger or a multiple shaft force sensor is installed on a wrist portion of the arm, it is difficult to distinct vibration due to stiffness of the multiple joint arm (eigenfrequency is as high as ten several Hz) from variation due to contact and collision, and that contact on the origin side of the arm cannot be detected with the multiple shaft force sensor arranged on the wrist portion.

When an output torque is detected based on a motor current as described in JP-A 2004-364396 (KOKAI), response is poor due to influence of a slowdown transfer element installed between a motor and an output shaft, and precision of current detection is poor due to large noise.

### BRIEF SUMMARY OF THE INVENTION

An aspect of the present invention provides a mobile robot comprising: a movable robot body; arms provided on the movable robot body, each of the arms having a multiple joint structure including plural joints, an actuator for actuating each of the joints and a shaft torque sensor incorporated in each of the joints to detect a torque from the actuator at an output shaft of each of the joints; and a controller provided in the robot body to determine whether each of the arms is in contact with or in collision with a peripheral obstacle or obstacles based on change of at least one of outputs from the shaft torque sensor and control an operation of each of actuators of each of the arms.

### BRIEF DESCRIPTION OF THE SEVERAL VIEWS OF THE DRAWING

FIG. 1 is a block diagram illustrating diagrammatically a control system of arm-equipped mobile robot concerning an embodiment.

FIG. 2 is a diagram illustrating one work example in the operation mode information module shown in FIG. 1.

FIG. 3 is a top plan view of the robot schematically illustrating an arm holding posture due to a movement condition at the time when the mobile robot moves to a particular location.

FIG. 4 is a side elevation of the robot schematically illustrating an arm holding posture due to a movement condition at the time when the mobile robot moves to a particular location.

FIG. 5 is a top plan view of the robot schematically illustrating an arm holding posture due to a movement condition at the time when the mobile robot moves to a particular location.

FIG. 6 is a top plan view of the robot schematically illustrating an arm holding posture due to a movement condition at the time when the mobile robot moves to a particular location.

FIG. 7 is a front view of the robot schematically illustrating an arm holding posture due to a movement condition at the time when the mobile robot moves to a particular location.

FIG. 8 is a block diagram for executing a detection method of determining contact or collision by the output of an axle torque sensor incorporated in the arm.

FIG. 9 is a graph showing torque characteristics for explaining a detection method of determining contact and collision by the output of a torque sensor incorporated in an arm.

FIG. 10 is a graph showing torque characteristics to explain a detection method of determining contact and collision by the output of a torque sensor incorporated in an arm.

### DETAILED DESCRIPTION OF THE INVENTION

There will now be described an arm-equipped mobile robot and a control method for controlling the same according to the embodiment referring to the drawing.

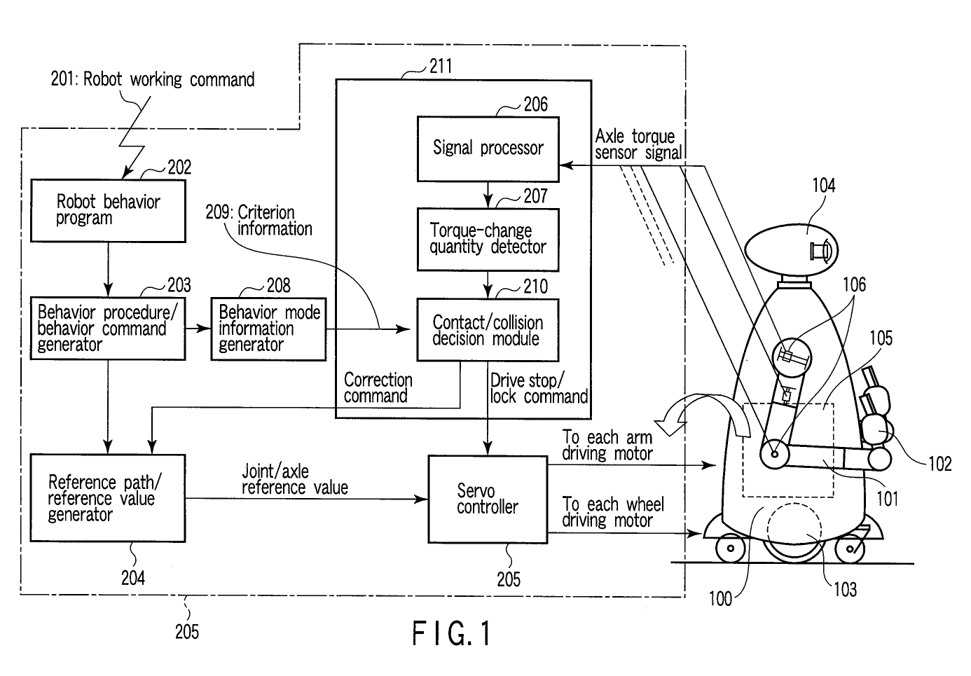

As shown in FIG. 1, an arm-equipped mobile robot 100 (self-propelled robot) comprises a movable robot body having wheels for movement and multiple joint work double arms (referred to as arms) 101 mounted on the robot body and having a multiple joint structure for work, one of which is shown in FIG. 1. A clamping mechanism 102 capable of handling an object is installed at the tips of the multiple joint work arm 101. Further, the arm-equipped mobile robot 100 comprises a locomotive mechanism 103 to move the arm-equipped robot 100 by driving wheels, a camera-equipped head 104 installed on the upper part of the arm-equipped mobile robot 100 and equipped with a video camera, and a controller unit 105 equipped in the arm-equipped mobile robot 100 and operated by a battery (not shown).

Shaft torque sensors 106 are incorporated in joints of each arm, respectively. Each shaft torque sensor 106 detects a torque occurring in an output shaft through a transmission from an actuator for driving the joint. The output signal of the shaft torque sensor 106 is supplied as a torque signal to the controller 105 via a signal processor including an amplifier, etc. The shaft torque sensor 106 uses a magnetostrictive torque sensor comprising a magnetrostrictive material evaporated to the output shaft and a detection coil or a strain sensor attached directly to the output shaft to detect a shearing stress of the output shaft in bridge configuration. Since these sensors are well known, illustration and explanation are omitted.

In FIG. 1, configuration of the controller 105 provided in the robot is shown together with a flow of an operation process corresponding to a working command issued at the time when the robot operates.

When a robot working command 201 concerning a sequence of behaviors imposed to the robot by a person or program is input to a robot behavior program module 202, the working command 201 is disassembled into plural operation steps necessary for each working process in the robot behavior program module 202. As a result, the robot is programmed according to the working command 201 to execute the sequence of behaviors. The working command 201 may be input from panel displayed commands or instructed by speech. An input unit (not shown) for inputting the working command 201 may be mounted on the robot or configured to make it possible to communicate with the robot by wire communication or wireless communication.

A behavior procedure/behavior command generator 203 develops a behavior procedure created by the robot behavior program module 202 to a command sequence of behavior command level for each unit actuator such as the arm 101 or locomotive mechanism 103. A reference valuereference path/reference value generator 204 calculates each reference path and reference value for each actuator such as the arm 101, transfer wheel, camera head according to each behavior command and outputs a reference value instruction value for actuating each joint or each wheel. A servo controller 205 controls each actuator such as the arm, transfer wheel, etc. so that each actuator carries out an operation corresponding to the work according to the reference value command value from the reference valuereference path/reference value generator 204.

A signal from the shaft torque sensor 106 incorporated in each joint output shaft of the arm 101 is taken in a safety controller 211 as a digital detection value through a signal processor 206 including an amplifier and a filter. A torque-change quantity detector 207 detects a temporal change of each sensor output value by arithmetic processing to obtain a difference change quantity with respect to previous sampling from the output value of the shaft torque sensor 106 for each sampling. The behavior procedure/behavior command generator 203 sends behavior mode information corresponding to the operation command issued and executed according to the sequential works together with information for an execution work to a behavior mode information module 208.

To the behavior mode information module 208 are set detection reference values for detecting and determining contact or collision with the peripheral obstacles with respect to the output value from the shaft torque sensor 106 which is defined for each behavior mode included in various work commands. The behavior mode information module 208 compares a detection reference value corresponding to the currently executing behavior mode with each output value from the torque-change quantity detector 207. The behavior mode information module 208 sends a command for a motor drive stop or servo lock to the servo controller 205 or sends a command for correcting a reference path or a reference value to the reference valuereference path/reference value generator 204 based on a method of dealing with contact or collision with each actuator according to a defined behavior mode from a contact/collision decision module 210 when the contact or collision is detected. In other words, the behavior mode information module 208 controls each actuator to secure safety by implementing a coping process suitable for a current behavior with respect to contact or collision.

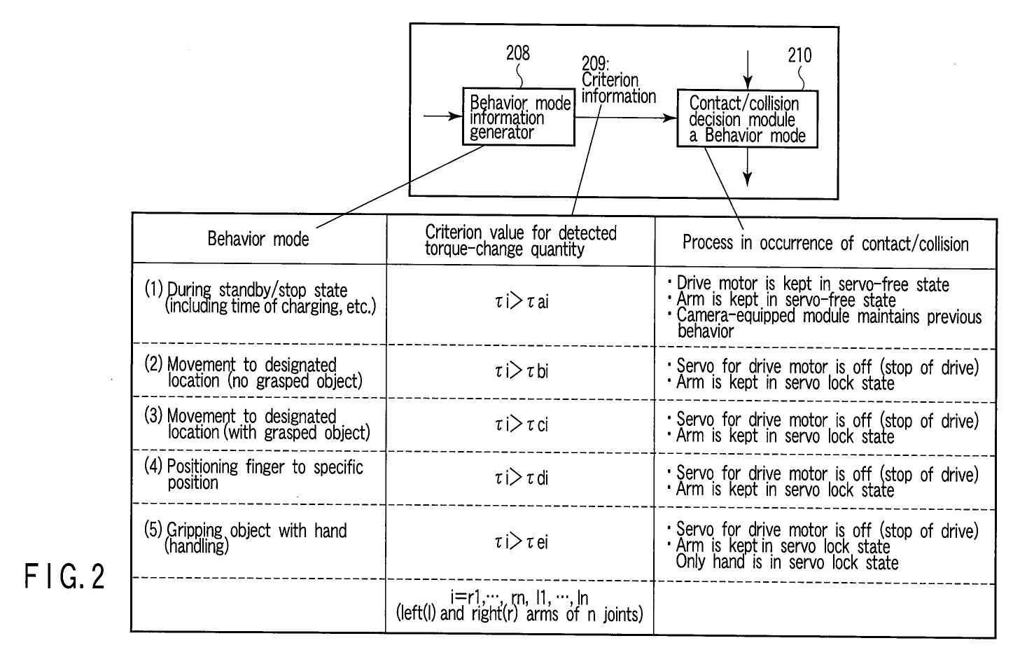

There will now be explained a work setting example in the behavior mode information module 208 referring to FIG. 2. FIG. 2 illustrates a work example in the behavior mode information module 208, for example, an example of contents to be defined and set to each behavior mode necessary for a work bringing a designated object from a current position to a specific location. As shown in FIG. 2, five behavior modes are defined as a kind of behavior modes as follows:

(1) A standby state or motion stop status in the specific location,

(2) A movement of the robot to the specific location without grasping,

(3) A movement of the robot to the specific location with a grasped object,

(4) A positioning operation of positioning the fingers of the robot to a specific position with little movement, and

(5) A handling operation of handling an object by the arm 101 and a finger clamping mechanism.

The detected torque change quantities τai, τbi, τci, τdi, τei (i=r1, . . . , rn, 11, . . . , ln, n: the number of joints of right and left arms) are established as criterion information 209 for determining contact and collision with respect to each operation mode. In the case where the contact/collision decision module 210 determines existence of contact and collision based on criterion information 209, the servo controller 205 or reference valuereference path/reference value generator 204 sets a corresponding coping process to each actuator. As shown in FIG. 2, the actuator can define the process according to respective behavior modes such as stop of the motor, keeping of the posture by keeping servo lock, keeping of servo free.

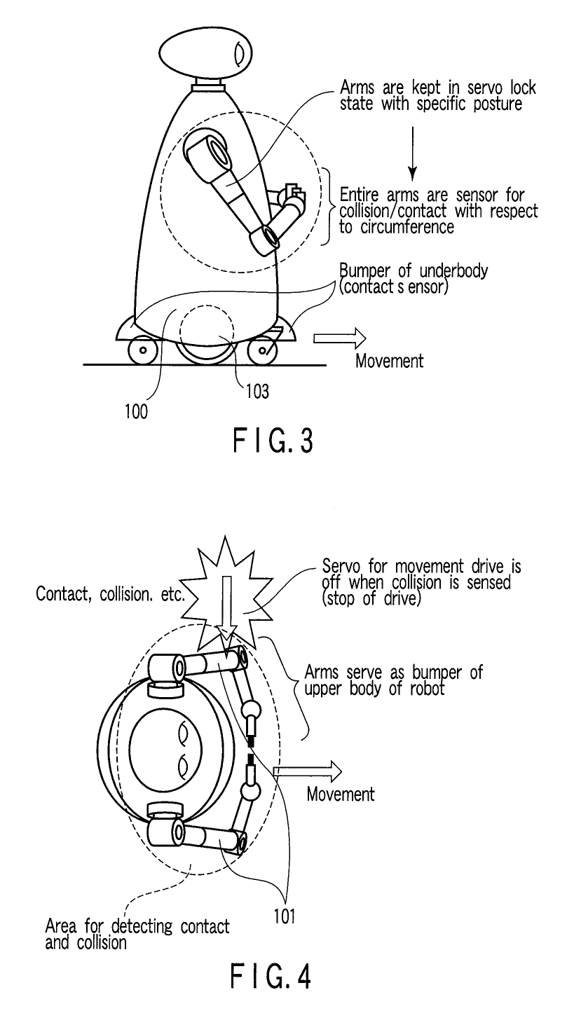

An example of employing the arm 101 as a contact/collision sensor is explained referring to FIG. 3 and 4. An ultrasonic sensor detecting obstacles by non-contact or a bumper for directly detecting contact with obstacles is usually installed on the round of the locomotive wheel of the mobile robot as shown in FIG. 3. In the present embodiment, when the robot moves in an arrow direction as shown in FIGS. 3 and 4, the arm 101 is kept in a servo lock state with a specific posture. By using the output of the shaft torque sensor 106 incorporated in each joint shaft of the arm 101, the shaft torque sensor 106 functions as a safety device to detect contact or collision with the arm 101 and the upper body of the robot. When the contact or collision is detected, a coping action such as stop of the motor for driving the wheels of the locomotive mechanism 103 is executed.

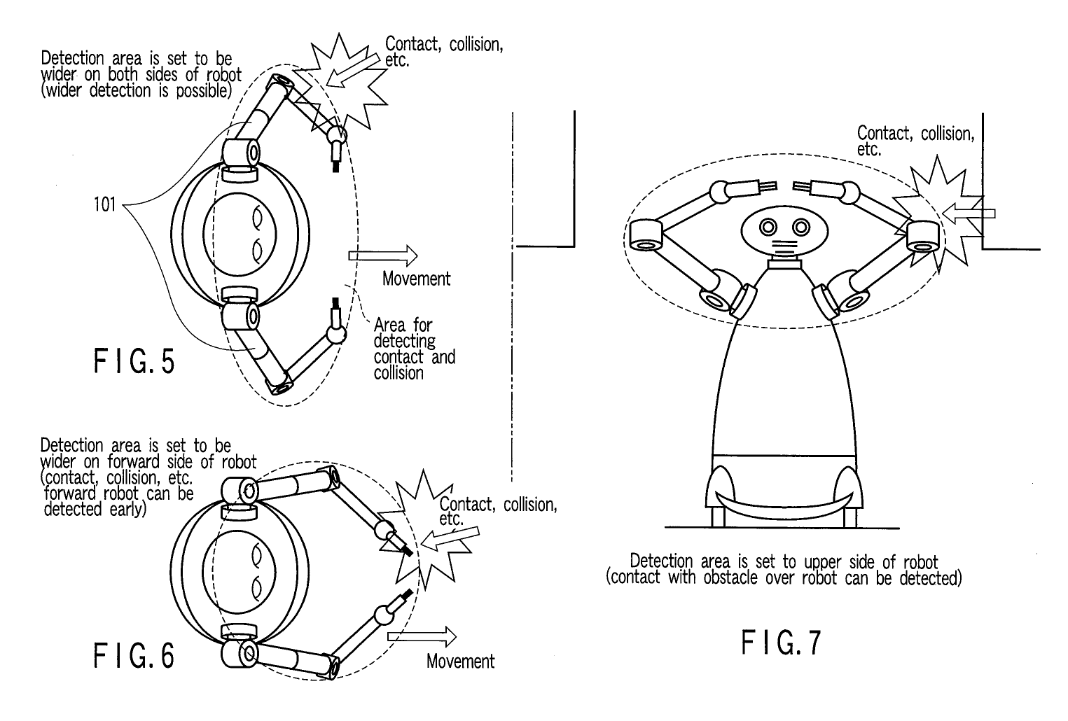

As shown in FIGS. 5-7, the detection region around the robot can be changed as needed by changing the posture of the arm holding an object, according to the movement condition of the robot based on a kind of executing work or the current condition. As a result, the torque sensor 106 can be operated effectively as a contact/collision detector for detecting contact or collision of the arms 101 with the peripheral obstacles. For example, the detection area is changed according to the width of a passageway through which the robot passes or according to a work that the robot passes through a small area such as a door or a border between rooms or a work of whether or not the robot arms grasp an object. Alternatively, the detection area is changed for the purpose of making the posture expanding the robot arms in the lateral directions and forward direction (FIGS. 5 and 6) or making the posture narrowing the robot arms in the lateral directions and forward direction.

It is availability to make a function as a safety device which detects contact and collision with the peripheral obstacles by changing the arm posture according to environmental condition effectively, for example, by keeping the posture of the arms in the upper side (FIG. 7) or lower side with respect to the height of the robot by the location to which the robot moves.

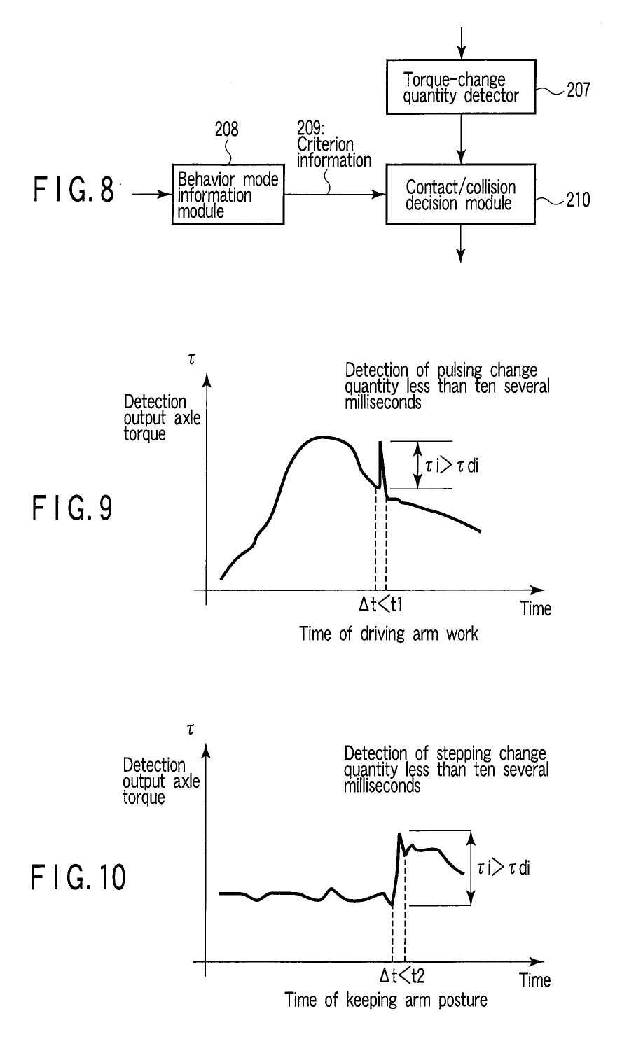

A detection method of detecting contact or collision with person or peripheral objects in precision and easily using the output of the torque sensor 106 is described in conjunction with FIGS. 8-10 hereinafter. In general, a working arm has a cantilevered structure, so that vibration is apt to occur by the drive operation of the arm itself due to influence of hardness of the driving mechanism of each joint. The vibration influences the output value of the shaft torque sensor 106. The working arm equipped with the mobile robot has primary eigenfrequency affected by the vibration due to lightweighting, but the eigenfrequency is as low as ten several Hz. Accordingly, the output value of the torque occurred by contact and collision with the peripheral obstacles without receiving influence of the vibration needs to be distinguished from the output value of driving torque of the actuator to move each arm shaft along a specific reference path.

For this reason, in the present embodiment, the detection unit as shown in FIG. 8 is used for detecting contact or collision with a person or obstacles with the torque sensor 106 incorporated in each output shaft of the arm 101.

This detection unit comprises the behavior mode information module 208 to output the criterion information 209, the torque-change quantity detector 207 and the contact/collision decision module 210. Each torque-change quantity detector 207 fetches an output value by sampling in unit of several milliseconds from each torque sensor 106, and calculates a difference change quantity between the output value and the last output value to output it to the contact/collision decision module 210. When the difference change quantity satisfies a predetermined condition, the contact/collision decision module 210 determines that contact or collision is detected.

Concretely, when a pulse-shaped change occurs at the time of driving the arm work (FIG. 9), and when a step-shaped change occurs at the time of keeping the arm posture (FIG. 10), it is determined that contact or collision is detected. At this time, if the time (period) during which the change occurs is within ten several milliseconds (Δt<t1, Δt<t2), and longer (τi>τdi, τi>τbi) than that of the criterion information 209 corresponding to the current behavior mode set to the behavior mode information module 208 in either joint shaft, it is desirable that it is determined that contact or collision with the peripheral obstacles occurs in the arm part located on the tip side from the detected joint shaft.

If the posture such as arm holding posture is known beforehand and the working torque quantity in each joint output shaft due to the empty weight of the arm itself is obtained beforehand, the method of higher detection accuracy can be provided by detecting contact or collision using compensated value obtained by subtracting the empty torque quantity from the output value of the shaft torque sensor 106.

As described above, there is provided an arm-equipped mobile robot having very high safety against contact or collision with a person or peripheral obstacles. Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A mobile robot comprising:
a movable robot body having wheels for movement;
arms provided on the movable robot body, each of the arms having a multiple joint structure including plural joints, an actuator for actuating each of the joints and plural shaft torque sensors incorporated in each of the joints to detect a torque from the actuator at an output shaft of each of the joints; and
a controller provided in the robot body to determine whether each of the arms is in contact with or in collision with a peripheral obstacle or obstacles based on change of at least one of outputs from the shaft torque sensors and control an operation of each of actuators of each of the arms.

2. The mobile robot according to claim 1, wherein the controller determines the contact or collision when a pulsed change or stepped change is detected as the change.

3. The mobile robot according to claim 1, wherein the controller comprises a behavior mode information module in which a plurality of behavior modes, a criterion reference of torque change quantity set corresponding to each of the behavior modes and a coping process for contact or collision set corresponding to each of the behavior modes are defined.

4. The mobile robot according to claim 3, wherein the controller keeps the arms in a servo lock state with a predetermined posture in a movement mode of the behavior modes.

5. The mobile robot according to claim 3, wherein the controller determines the contact or collision when a pulsed change or stepped change is detected as the change.

6. The mobile robot according to claim 3, wherein the shaft torque sensor comprises a magnetostrictive torque sensor comprising a magnetrostrictive material evaporated to the output shaft and a detection coil or a strain sensor attached directly to the output shaft to detect a shearing stress of the output shaft in bridge configuration.

7. The mobile robot according to claim 3, wherein the controller includes a robot behavior program module to program a sequence of behaviors of the robot according to a working command input by a person or program.

8. The mobile robot according to claim 1, wherein the controller comprises a detector to detect a torque change quantity of the shaft torque sensor, and an indicator to indicate a coping process for coping with contact or collision set corresponding to a current behavior mode when the contact or collision is determined by comparison of the criterion reference value with the change quantity.

9. The mobile robot according to claim 8, wherein the controller determines the contact or collision when a pulsed change or stepped change is detected as the change.

10. The mobile robot according to claim 8, wherein the controller keeps the arms in a servo lock state with a predetermined posture in a movement mode of the behavior modes.

11. The mobile robot according to claim 8, wherein the shaft torque sensor comprises a magnetostrictive torque sensor comprising a magnetrostrictive material evaporated to the output shaft and a detection coil or a strain sensor attached directly to the output shaft to detect a shearing stress of the output shaft in bridge configuration.

12. The mobile robot according to claim 8, wherein the controller includes a robot behavior program module to program a sequence of behaviors of the robot according to a working command input by a person or program.

13. The mobile robot according to claim 1, wherein the shaft torque sensor comprises a magnetostrictive torque sensor comprising a magnetrostrictive material evaporated to the output shaft and a detection coil or a strain sensor attached directly to the output shaft to detect a shearing stress of the output shaft in bridge configuration.

14. The mobile robot according to claim 1, wherein the controller includes a robot behavior program module to program a sequence of behaviors of the robot according to a working command input by a person or program.

15. A method for controlling a mobile robot having arms each having a multiple joint structure, comprising:
detecting a torque from an actuator for driving each joint of the arms at an output shaft of each joint using a shaft torque sensor incorporated in each joint of the arms;
determining whether the arms are in contact with or in collision with peripheral obstacles based on a change of at least one of outputs from the torque sensors; and controlling an operation of the actuators based on a determination result.

16. The method according to claim 15, further including detecting a torque change quantity of the torque sensors, and executing a coping process for coping with contact or collision set corresponding to a current behavior mode when the contact or collision is determined by comparison of a criterion reference value with the change quantity.
